(19) United States
(12) Patent Application Publication
(10) Pub. No.: US 2025/0314233 A1
(43) Pub. Date: Oct. 9, 2025

(54) INTEGRATED SENSOR FOR COMPOSITE MATERIALS

(71) Applicant: Footfalls and Heartbeats (UK) Limited, Nottingham (GB)

(72) Inventors: Madeleine Alice OAKLEY, Nottingham (GB); Thomas John PAYNE, Nottingham (GB); Simon Adair MCMASTER, Nottingham (GB)

(21) Appl. No.: 18/865,589

(22) PCT Filed: May 12, 2023
(86) PCT No.: PCT/GB2023/051258

§ 371 Date: Nov. 13, 2024

(30) Foreign Application Priority Data
May 13, 2022 (GB) 2207052.8

(51) Int. Cl. F03D 1/06; B29C 70/22; B29K 105/08; B29L 31/08; B29L 31/30; B64C 3/00

(52) U.S. Cl. CPC F03D 1/0675; B64C 3/00; B29C 70/222; B29K 2105/0836; B29K 2995/0005; B29L 2031/085; B29L 2031/3085; F05B 2280/6003

(57) ABSTRACT

The invention provides a composite material comprising a fibre material, a resin and an array comprising a conductive yarn, wherein the spatial configuration of the array is configured to change in response to a load applied to the composite material such that the resistance of the conductive yarn changes. The invention also provides a method of making a composite material. The method comprises: providing a fibre material; arranging an array comprising conductive yarns around the fibre material; and setting the fibre material and the array in place using a polymer matrix.

### TECHNICAL FIELD

This invention belongs to the technical field of integrated sensors in composite materials.

### BACKGROUND

Composite materials are those made from two or more constituent materials. Reinforced plastics, such as glass fibre reinforced polymer (GFRP) and carbon fibre reinforced polymer (CFRP), are a subset of these materials. These reinforced plastics are formed when either glass or carbon fibres are mixed with and embedded into a polymer matrix, which is usually an epoxy, vinyl ester, or polyester thermosetting plastic. There are a multitude of polymer resins and it is noted that these will be chosen according to the final material properties required in either the GFRP or CFRP. The material properties of a fibre-reinforced plastic depends heavily on the mechanical properties of both the fibre and the polymer matrix, their volume relative to one another, and the fibre length and orientation within the matrix.

Carbon fibres, in particular, have several material properties which make them useful in structural manufacturing. These include high stiffness, high tensile strength, high strength to weight ratio, high chemical resistance, high temperature tolerance and low thermal expansion. CFRP is a material with a very high strength to weight ratio and stiffness (rigidity). This material property is extremely useful in aerospace, civil engineering, military, renewable energy and motorsport applications.

As a result of its material properties, CFRP materials are often used for components that experience significant forces while requiring a low weight. However, a notable problem with CFRP materials is the fact that structural failure of the material can be sudden and catastrophic due to the brittle nature of the carbon fibres themselves and the fact that only a small number of the carbon fibres are visible externally. Whilst it is possible to test CFRP components for internal voids and damage using, for example, ultrasound or thermography scanning, this is often impractical when the component is in use.

It is therefore desirable to monitor in real time the forces experienced by a CFRP component in order to recognise when the lifetime of a component is nearly over such that the component must be replaced and, if possible, to mitigate the forces acting on the component in order to prolong its lifetime.

Presently, the sensors used to measure the forces on a CFRP component include are foil-based strain gauges and optical fibre systems using Fibre Bragg gratings. Foil strain gauges (shown in FIG. 1) are an industry standard of measuring strain accurately and cost effectively in many industrial applications. They are able to transmit data very accurately from a small area.

Foil strain gauges measure a change in resistance caused by the change in the length and cross-sectional area of a wire due to an applied load. However, foil strain gauges often fail due to delamination from the surface of the component, especially when the component is used in extreme or hostile environments, as can often be the case for CFRP components. A foil strain gauge, being applied to the surface of the component is also unable to accurately measure stresses and forces within the component, which are often the cause of component failure. In addition, the small size of foil strain gauges means that, for large components, a large number of gauges are required across the surface of the component in order to measure the relevant areas.

Fibre optical sensors based on Bragg gratings, unlike foil strain gauges, can be embedded in a reinforced plastic material at manufacture. However, the presence of the fibre optical sensor can act as a stress concentrator and so can initiate microcracks in the component. Fibre optical sensors also require a dedicated stand-alone electronics unit, which is an expensive piece of apparatus and is limited by the number of sensors to which it can connect, which can be less than the number of sensors required to adequately cover the whole component.

It is against this background that the invention has been devised. These and other uses, features and advantages of the invention should be apparent to those skilled in the art from the teachings provided herein.

### SUMMARY OF THE INVENTION

According to a first aspect of the invention, there is provided a composite material comprising a fibre material, a resin and an array comprising a conductive yarn, wherein the spatial configuration of the array is configured to change in response to a load applied to the composite material such that the resistance of the conductive yarn changes.

The array may additionally comprise a non-conductive yarn. The density of the conductive yarn may vary across the array.

The array may be applied to the fibre material. The array may be laid into the fibre material and may alternatively or additionally be stitched to the fibre material. Preferably, the array is knitted to the fibre material, and in particular may be warp knitted to the fibre material.

The array may comprise a conductive yarn laid into a knitted bed of non-conductive yarns.

The array may comprise a variety of knitting stitches, including jacquard displacement actions. The array may incorporate different stitch patterns at different points so that the spatial configuration of the array varies thereacross.

The conductive yarn may comprise a core surrounded by a conductive coating. The fibre material may comprise carbon fibre.

The spatial configuration of the array may be configured to change in response to a load applied to the composite material such that the contact resistance of the conductive yarn changes. The contact resistance may change as a result of tunnelling of conduction electrons between neighbouring regions of conductive yarn.

The inventive concept extends to a wind turbine blade, or an aeroplane wing comprising the composite material discussed above.

According to a second aspect, the invention provides a method of making a composite material. The method comprises: providing a fibre material; arranging an array comprising conductive yarns around the fibre material; and setting the fibre material and the array in place using a polymer matrix.

The array may be arranged around the fibre material by laying the array into the fibre material. Additionally, or alternatively, the array may be stitched into the fibre material. Preferably, the array is knitted to the fibre material. In particular, the array may be warp knitted to the fibre material.

Different knitting patterns may be used across the array such that the spatial configuration of the array changes thereacross.

According to a third aspect, the invention provides a method of measuring the strain experienced by a composite material as discussed above, or made according to the method discussed above. The method comprises: measuring the change in resistance of the conductive yarns of the array; and relating the change in resistance of the conductive yarns to a strain experienced by the composite material.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

In describing the background to the invention, the following drawings have already been referenced:

FIG. 1, which schematically shows a foil strain gauge applied to the surface of a reinforced plastic component. In particular, FIG. 1(A) shows a foil strain gauge in an unstrained state, FIG. 1(B) shows the foil gauge under tensile strain and FIG. 1(C) shows the foil gauge under compressive strain.

So that it may be more readily understood, the invention will now be described with reference to the following drawings, in which:

FIG. 2 shows typical damage types in wind turbine blades, with FIG. 2(a) showing downwind skin damages, FIG. 2(b) showing damages to the outer surface of the main spar, FIG. 2(c) showing non-visible damages, and FIG. 2(d) showing damages to the internal surface of the main spar;

FIG. 3 shows leading edge erosion on a wind turbine blade;

FIG. 4 shows a knitting pattern used to knit an array of yarns to a fibre material;

FIG. 5 shows an alternative knitting pattern used to knit an array of yarns to a fibre material;

FIG. 6 shows another alternative pattern for an array of yarns knitted to a fibre material comprising a conductive yarn laid into a knitted bed of non-conductive yarns;

FIG. 7 shows a variety of stitch types and jacquard displacement actions that may be used to knit an array of yarns to a fibre material;

FIG. 8 shows an example of how the density of conductive yarns may vary across an array of yarns knitted to a fibre material;

FIG. 9 shows examples of how the stitch pattern may vary across an array of yarns knitted to a fibre material;

FIG. 10 shows an example of how jacquard displacement actions may be incorporated into an array of yarns knitted to a fibre material;

FIG. 11 shows the location of stitch lines on a carbon fibre reinforced polymer (CFRP) coupon used for experiments discussed herein;

FIG. 12 shows the different stitch patterns corresponding to the stitch lines shown in FIG. 11;

FIGS. 13 and 14 show how the resistance of a conductive yarn in an “S” and “Z” sensor, respectively, change on the progressive application and removal of a load when the conductive yarns are applied to a CFRP coupon;

FIG. 15 shows how the resistance of a conductive yarn applied to a CFRP coupon changes when at rest and unloaded;

FIG. 16 shows how the resistance of a conductive yarn applied to a CFRP coupon changes when a constant load is applied;

FIGS. 17 and 18 shows how the resistance of conductive yarns applied to a CFRP coupon in two different stitch patterns changes when an alternating load is applied;

FIGS. 19 and 20 shows how the alternating load was applied to the CFRP coupons to generate the results shown in FIGS. 17 and 18.

FIGS. 21, 23 and 25 show how the resistance of a conductive yarn applied to a CFRP coupon in respective stitch patterns changes when an alternating load is applied over a number of cycles; and

FIGS. 22, 24 and 26 correspond to FIGS. 21, 23 and 25, respectively but show a sample of the cycles of the alternating load.

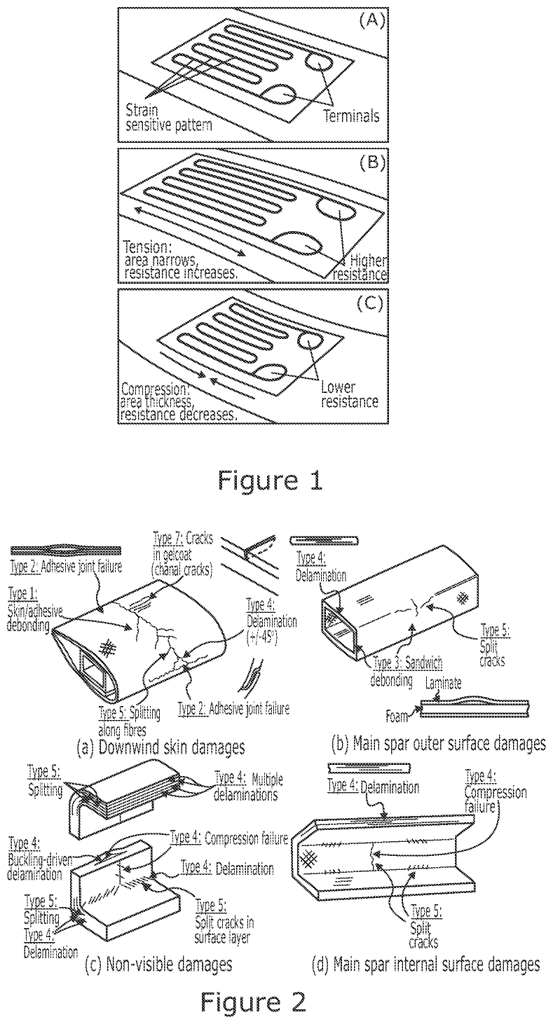

### DETAILED DESCRIPTION

All references cited herein are incorporated by reference in their entirety. Unless otherwise defined, all technical and scientific terms used herein have the same meaning as commonly understood by one of ordinary skill in the art to which this invention belongs.

Prior to setting forth the invention, a number of definitions are provided that will assist in the understanding of the invention.

As used in this description, the singular forms “a,” “an,” and “the” include plural referents unless the context clearly dictates otherwise. Thus, for example, the term “a sensor” is intended to mean a single sensor or more than one sensor or to an array of sensors. For the purposes of this specification, terms such as “forward,” “rearward,” “front,” “back,” “right,” “left,” “upwardly,” “downwardly,” and the like are words of convenience and are not to be construed as limiting terms.

As used herein, the term “comprising” means any of the recited elements are necessarily included and other elements may optionally be included as well. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

For the purposes of this application, a “multifilament yarn” is defined as a yarn formed of a plurality of fine continuous filaments grouped together. The filaments are generally continuous in length along the length of the yarn, so that each filament can be considered to extend along the length of the yarn. Multifilament yarns may comprise a twist in the yarn to facilitate handling.

As used herein, the term “staple fibre yarn” is defined as yarn formed of staple fibres, each having a discrete staple length. Many staple fibres are spun together to form a length of yarn, with the length of the yarn being much greater than the length of any individual staple fibre.

Strain is determined by the equation I:

$$ε = \frac{Δ l}{l}$$

in which ε represents the strain, Δl represents the change in length or dimension and l represents the original length or dimension.

Stress is determined by the equation II:

$$σ = \frac{F}{A}$$

in which σ represents the stress (or, equivalently, pressure) applied to a body as a result of a force, F, acting over an area A.

Electrical resistance is determined by the equation III:

$$R = \frac{ρ l}{A}$$

in which R represents the electrical resistance of a wire of length l and cross-sectional area A having an electrical resistivity ρ.

Contact resistance is determined by the Holm equation IV:

$${R}_{C} = \frac{ρ}{2} \sqrt{\frac{π H}{F}}$$

in which R_{C} is the contact resistance, ρ is the electrical resistivity of the material, H is the hardness of the material and F is the normal force. The Holm equation can also be represented as equation V:

$${R}_{C} = \frac{ρ}{2} \sqrt{\frac{π H}{nP}}$$

in which n is the number of contact points and P is the contact pressure.

As has already been discussed, structural failure of a composite material such as a reinforced plastic can occur suddenly and without warning. This failure can result from a number of causes, such as: impact from external objects such as hail, rain, stones or debris; propagation of microcracks in the structure of the composite material due to impact or the presence of non-homogeneous structures within the material, such as integrated fibre optical sensors; poor manufacturing quality of parts of the composite material or of the structure of the composite material itself; and due to tensile forces causing shear of the polymer matrix at the interface between the matrix and the fibres to separate the fibres from the matrix or causing the fibres themselves to fracture.

Using a wind turbine blade as an example, some typical damage types are shown below in Table 1, while FIG. 2 shows how these damage types may manifest themselves in the sections of a wind turbine blade. Of these damage types, only those shown in FIG. 2(a) are visible externally to the wind turbine bade itself, which causes problems for monitoring the current health or remaining lifetime of the turbine blade.

TABLE 1
Typical damage types to wind turbine blades

| Type | | |
|---|---|---|
| No. | Damage Type | Internal/Outer |
| 1 | Skin/adhesive or main spar/adhesive layer | Outer |
| | debonding | |
| 2 | Adhesive joint failure between skins | Outer |
| 3 | Sandwich panel face/core debonding | Outer |
| 4 | Delamination driven by tensional or buckling load | Internal |
| 5 | Fibre failure in tension, laminate failure in | Internal/Outer |
| | compression | |
| 6 | Skin/adhesive debonding induced by buckling | Outer |
| 7 | Cracks or debonding of the gel coat | Outer |

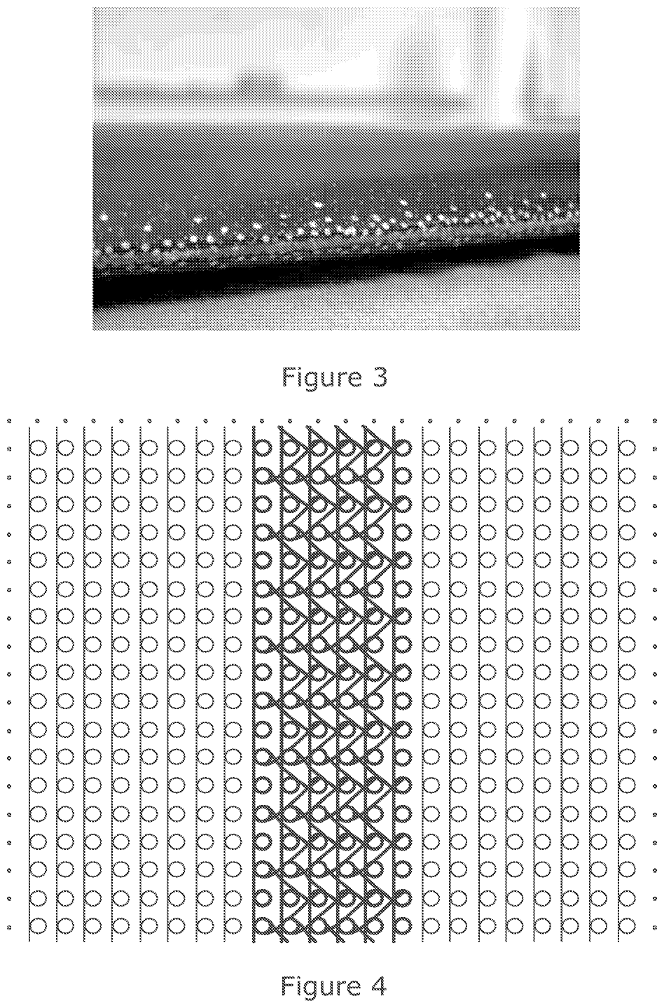

In parallel to the structural damage seen in FIG. 2, an area of considerable need for monitoring for wind turbine blades is that of leading edge erosion. It has been noted that leading edge blade erosion and debris accretion and contamination can dramatically reduce blade performance, particularly in the high-speed rotor-tip region that is crucial to optimum blade performance and energy capture. FIG. 3 shows leading edge erosion on a wind turbine blade in a controlled environment. During the microseconds of a rain load striking the blade tip during operation of the wind turbine, a force of up to 100 MPa can be applied to the blade tip. While these loads are not catastrophic themselves, they can cause erosion of the leading edge over the course of the lifetime of the blade, and can result in an annual energy loss of between 3 to 5%.

Although discussed above mainly in the context of wind turbine blades, the solution provided by one embodiment of the invention can be utilised in all forms of composite material manufacture currently used to create structural CFRP and GFRP components.

The invention enables the embedding of a sensor into a composite material in order to detect forces and stresses applied to the composite material and components made thereof. The sensor is comprised of at least one conductive yarn, fibre or filament. As will be discussed in greater detail below, the sensor can be integrated into the composite material using a variety of methods, including weft knitting, warp knitting, braiding, sewing, embroidery or fibre placement.

The integrated sensor of the invention makes use of the well-known relationship between an applied strain and a change in electrical resistance and also the methodology of changing the amount and placement of contact points in a knitted structure to allow accurate measurement of the applied loads and, therefore, the forces. An array, or matrix, comprising the conductive yarns is arranged that is ‘set’, or fixed in place, with respect to the composite material when the polymer resin is added during manufacture of a composite component. Within the wider array, it will be appreciated that the conductive yarns create their own array and so references to an array hereinafter may relate to the conductive yarns only, the wider array comprising the conductive yarns, or both arrays equally.

The yarns may be applied into the composite in a number of ways. For example, the array may be laid onto or into the carbon fibre material before the polymer resin is introduced, or the yarns of the array may instead be stitched or braided onto the carbon fibre. Preferably, however, the array is knitted, and in particular warp knitted, and the yarns of the array may be used to knit together swatches of carbon fibre material, as would typically be done using non-conductive yarns, especially for multiaxial CFRP components. In this way, the conductive yarn of the array simply replaces all or a part of a non-conductive yarn in an existing manufacturing step. The knitting does not need to involve conductive yarns exclusively and in many cases, the yarns used to knit together the carbon fibre swatches will be a combination of conductive and non-conductive yarns.

The array can be created using a number of different patterns. For example, when the array is knitted into the carbon fibre, the array may be warp knitted according to the pattern shown in FIG. 4, in which the conductive yarn (shown in black) is knitted with a combination of closed chain stitches and closed silk laps on the front and back bar, respectively.

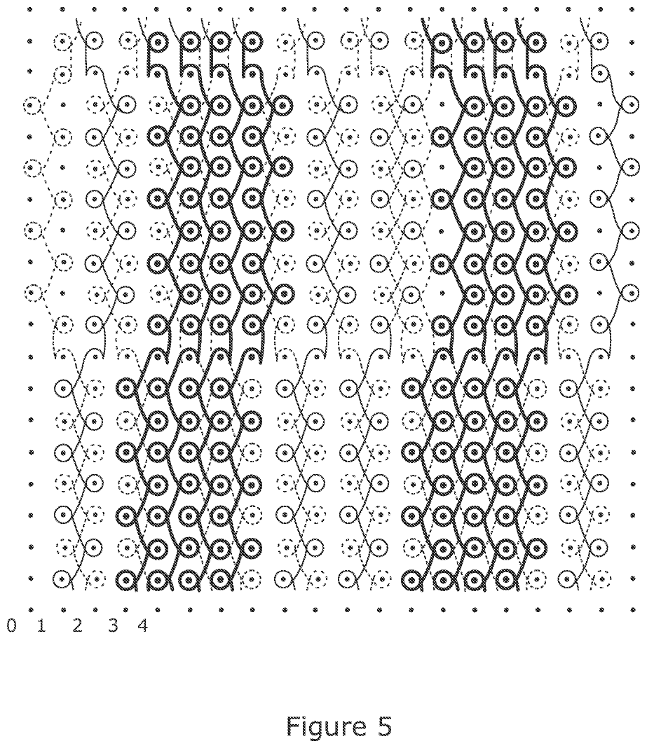

Alternatively, the array of conductive yarns may be created as part of a warp knitted mesh, as seen in FIG. 5. Here the conductive yarn (shown in black) is used only on the front bar and is knitted with closed cotton laps, along with jacquard displacements to create the mesh structure. A non-conductive yarn is used on the back bar (shown in dashed lines) and also the front bar (in grey), again using a combination of closed cotton laps and jacquard displacements.

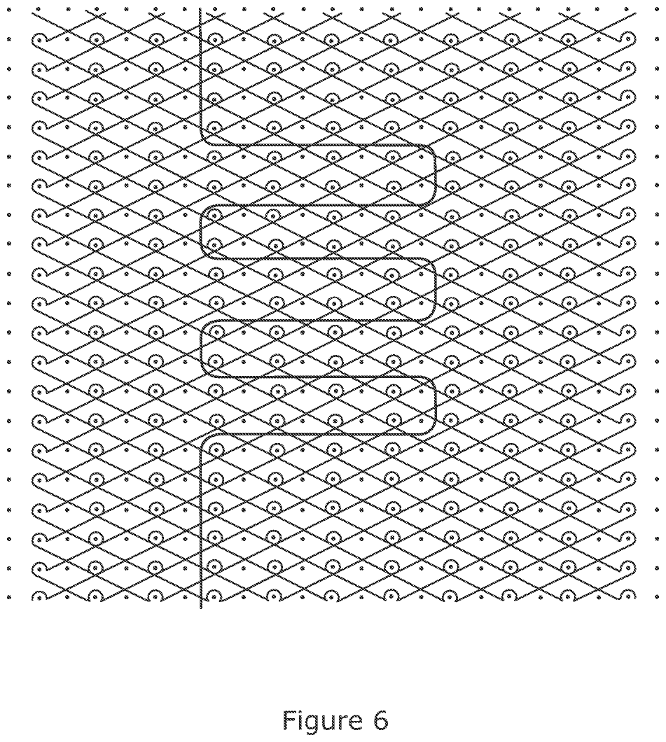

The conductive yarn may also be simply laid in on a knitted bed of non-conductive yarns. FIG. 6 shows a conductive yarn laid into knitted non-conductive yarns that are knitted using open silk laps.

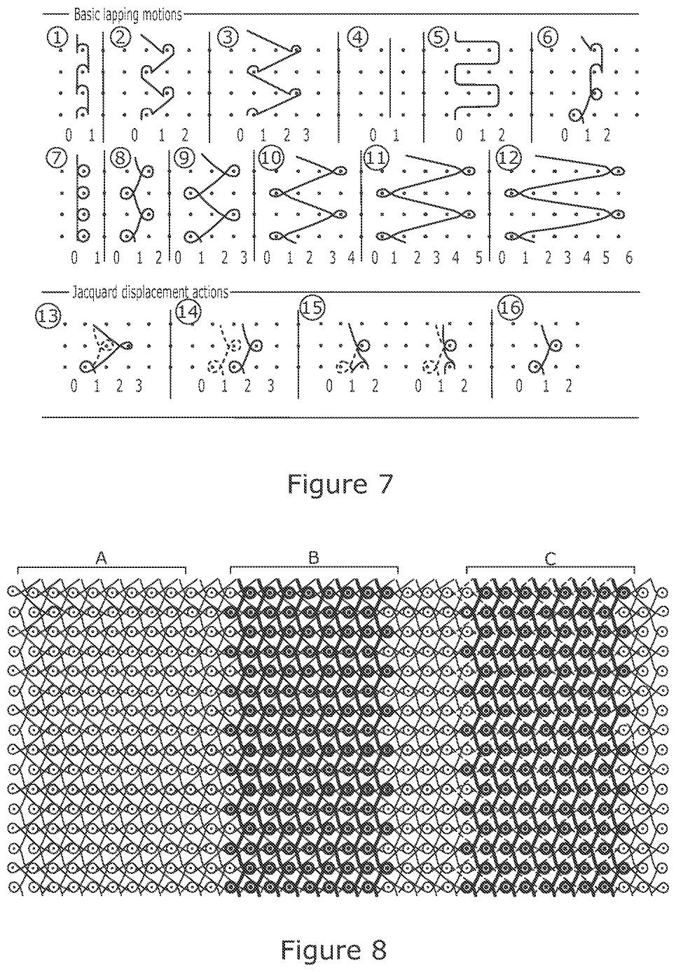

The exact nature of the stitch patterns used to knit the array into the carbon fibre can vary and may be altered in dependence on the component, or location within the component where the carbon fibre to which the conductive yarn is knitted is to be used. FIG. 7 shows some other basic warp knitting stitches and jacquard displacement actions that may be used. Following the numbering 1-12 shown in FIG. 7, these stitches include an open chain (pillar stitch); open cotton lap (two needle float); open silk lap (three needle float); miss-lapping; laid in; mixed stitches (combined lapping); closed chain (pillar stitch); closed cotton lap (two needle float); closed silk lap (three needle float); closed satin lap (four needle float); closed super satin lap (five needle float) and a closed slipper satin lap (six needle float). Examples of suitable jacquard displacements are shown in numbers 13-15 in FIG. 7 and, again following the numbering in the Figure, include moving the second stitch to the right, moving both stitches to the right or moving the first stitch to the right. The skilled person will be aware of other possible stitches to be used in the stitch pattern and will understand that all lapping motions can be either open or closed and may begin by shogging either left or right depending on the desired stitch structure. Jacquard displacements, although shown moving stitches to the right in FIG. 7, may equally move stitches to the left in the same way.

In addition, the density of the conductive yarn may vary across the array, i.e., the number or amount of conductive yarns may change across the array. FIG. 8 shows three regions, A, B and C. In region A, a non-conductive yarn is used on the front and back bars, while in region B, a conductive yarn (shown in black) is used for the back bar only. In region C, a conductive yarn is used for both the front bar (shown in dashed lines) and the back bar (shown in black). Changes in the density of the conductive yarn may be required in order to optimise the ability of the sensor to detect and measure applied loads, depending on the shape of the component, or the structure of the composite material in that region. For example, some regions of a composite component may employ different fibre lay-ups or may utilise different proportions of fibre to resin and these factors may influence how loads are sensed by the array.

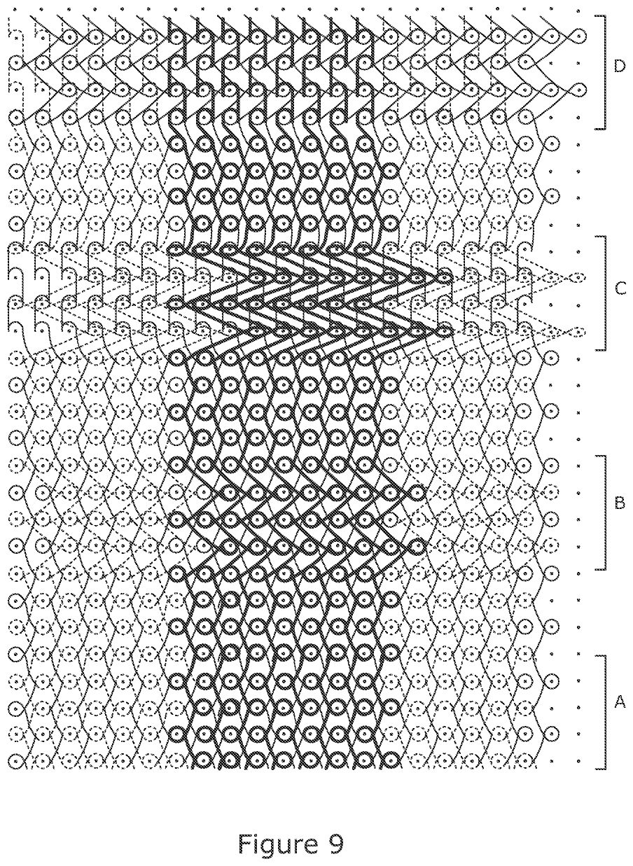

In a similar way, the stitch pattern may vary so that the spatial configuration of the array changes thereacross. In FIG. 9, a variety of different regions A-D show how the stitch pattern may vary across a knitted structure, with the stitch pattern varying along the length of the wale. In all regions, the conductive yarn is present on the front bar and is shown in black. In region A, the yarns form a double tricot pattern, with closed cotton laps on both the front and back bars. A double tricot structure is also shown between each of the regions. In region B, a locknit pattern is formed using a closed silk lap on the front bar and a closed cotton lap on the back bar. In region C, a Queen's cord pattern is formed using a closed satin lap on the front bar and an open chain stitch on the back bar, while in region D, a Delaware pattern is formed from an open chain stitch on the front bar and a closed silk lap on the back bar. The skilled person will appreciate that the array may comprise other patterns to those seen in FIG. 9, and that these patterns are not intended to be limiting.

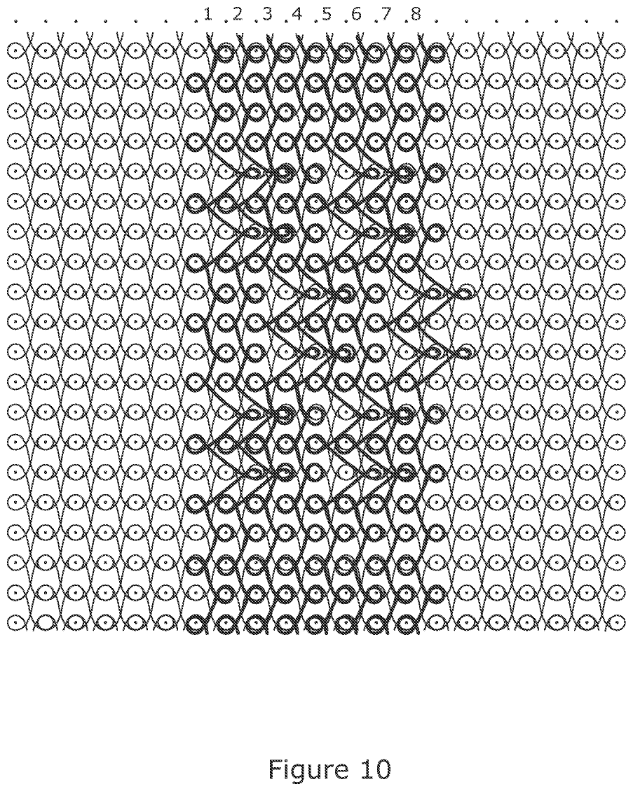

Finally, as alluded to above, jacquard displacement actions can be incorporated into the knitted structure of the conductive and/or non-conductive yarns. As the skilled person will know, in jacquard warp knitted fabrics, individual needles on the guide bar can be displaced in order to form varying stitches and shogging motions within one course. The example shown in FIG. 10 illustrates an alternation between one displacement action being applied twice to half the conductive yarns (again shown in black) and then the same displacement action applied twice to the other half of the conductive yarns. There are eight conductive yarns utilised in the pattern shown in FIG. 10 and, numbering the conductive yarns from 1 to 8 as shown in the Figure, the displacement action is first applied to yarns 1, 2, 5 and 6 and then to yarns 3, 4, 7 and 8. The conductive yarns are knitted onto a simple bed consisting of a double tricot pattern. Using this technique, a variety of structures can be easily implemented into one piece of fabric to allow an optimal structure to be created to sense the loads applied to a particular component made from composite material.

When a stress or force is applied to the composite material, or a component made thereof, a strain (change in dimension) is experienced by the material. With the array of conductive yarns located in place in the composite material and set fixedly by the polymer resin, the array of conductive yarns becomes mechanically coupled to the surrounding composite material. Consequently, any strain experienced by the composite material is also experienced by the integral conductive yarn array, causing the spatial configuration of the array to change. This consequently causes a change in the resistance of the conductive yarn, which can be measured and calibrated to the stress applied to the composite material, or the strain experienced thereby, depending on which parameter is of interest.

Without wishing to be limited by theory, it is believed that there are several different mechanisms at play in affecting how the resistance of the conductive yarn changes as a result of an applied strain. With regard to contact resistance, as the conductive yarns are set in place by the polymer matrix of the composite material, there is, theoretically at least, a thin film of resin covering the yarn filaments within the composite structure. This film would prevent the yarns from contacting and hence increasing the contact areas and decreasing the resistance in proportion to the applied force or load. However, the applied load may also affect the spatial configuration of the array of the conductive yarn to move to a configuration in which a form of tunnel effect is observed, in which conduction electrons can penetrate a thin film of resin separating one yarn, or region thereof, from a neighbouring yarn or region. In this way, an applied load may act to decrease the contact resistance of the conductive yarn.

For knitted sensors, the high fibre orientation used in the knitting process may also cause an enhanced electrical conductivity to occur within the knitted yarn sensors. The greater conductivity results in an enhanced tunnel effect due to a higher voltage being carried within the conductive yarn.

The applied load may also cause a change in the cross-sectional area of the yarn and so alter the resistance in this way. As indicated in the equation Ill above, electrical resistance is inversely proportional to cross-sectional area and so a decrease in the cross-sectional area, typically when the composite material is under a tensile load, will cause an increase in the resistance of the conductive yarn. The resistance may also be affected by a corresponding change in length of the conductive yarn. The length of a conductor and its resistance are directly proportional and so an increase in the length of the conductive yarn as a result of an applied tensile strain will cause a corresponding increase in its resistance.

In practical situations, the change in resistance of the conductive yarn is determined by a combination of the above proposed factors, which will be affected by the exact nature of how the conductive yarn is applied into the composite material. The change in resistance can be calibrated to the strain experienced by the composite material, and therefore to the stress applied to the material, in way that will be understood by those skilled in the art.

The integrated sensor of the invention therefore enables the monitoring of composite structures, such as those made from CFRP. As discussed above, structural monitoring of composite materials is important to prevent at worst, structural failure, in addition to giving the ability to assess remaining product lifetime, predict the need for product maintenance and, in some cases increase the efficiency of asset output. Each of these events when properly monitored will save money and/or add value. Returning to the example of a wind turbine blade, a collapsed or structurally unstable wind turbine is a significant cost event for both OEM and operator. Monitoring the structural integrity of wind turbine blades and using the data gathered in “digital twins” alongside a predictive maintenance schedule will extend asset lifetime and hence value for the owner. It is also noted that monitoring the aerodynamic performance of the blades may allow wake steering and individual blade pitch control to improve energy production efficiency. Even a small increase in this efficiency, perhaps 1%, will add very significant increase to the profit from a wind farm asset over a 30-year lifespan.

The conductive yarn sensor is further aided by the ‘solid’ nature of the substrate in which it can be embedded or otherwise integrated. It is noted that composite materials can use either thermoset or thermoplastic resin to complete the matrix. Both form a solid structure, although thermoplastic resins will typically allow more deformation and movement as a result of their lower stiffness when compared to thermoset resins. This deformation is intrinsic to the composite and does not affect the function of the sensor in any fundamental way, except that larger strains will typically occur for the same applied stress in a composite employing a thermoplastic resin than one using a thermoset resin.

The sensors may be used in any composite structures where monitoring of the loads experienced by the structure is of interest. The sensors may therefore find particular use in wind turbine blades, as already discussed, but also in aerospace fairings or other structures such as aircraft wings, in parts for road vehicles and in marine components.

The invention is further exemplified in the following non-limiting examples.

### EXAMPLES

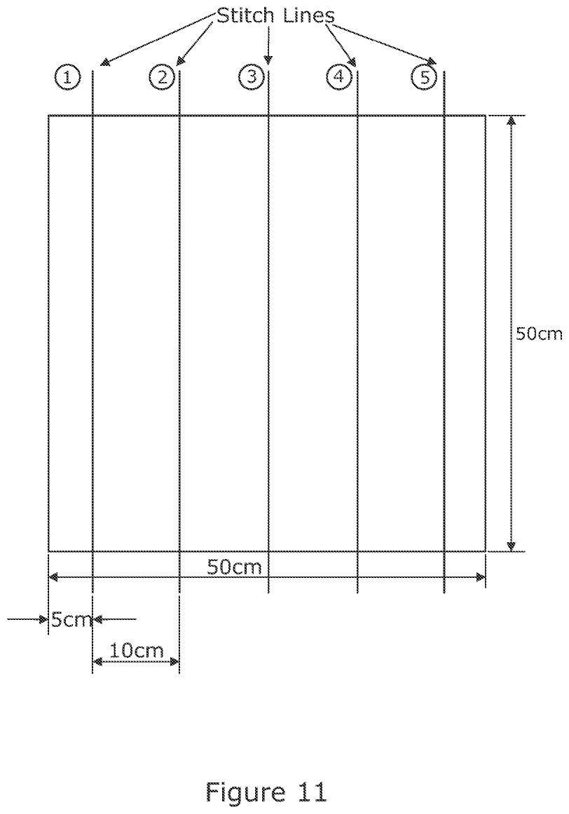

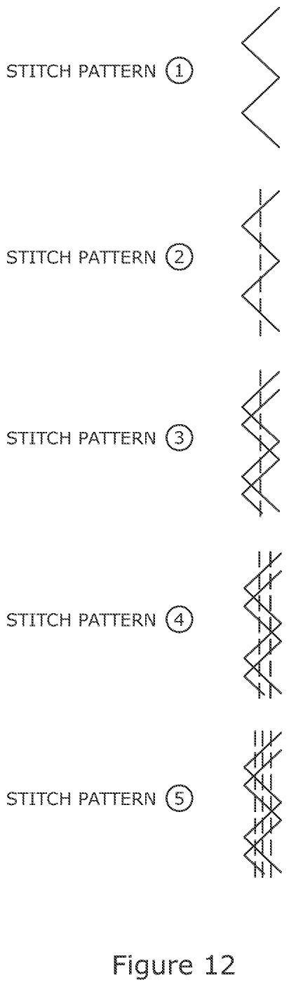

The following experiments were carried out to test the resistance response of a conductive yarn applied to coupons made from CFRP. In the experiments, a number of different stitch patterns were tested, as shown in FIGS. 11 and 12. Each coupon had five stitch lines applied thereto, with the stitch patterns 1 to 5 of FIG. 12 being positioned along stitch lines 1 to 5 shown in FIG. 11. Aside from stitch pattern 1, the stitch patterns comprise a mixture of straight stitches and zigzag stitches, with stitch pattern 1 consisting of a zigzag stitch only. The straight stitches were sewn in and the zigzag stitches were sewn in using fibre placement. The basic stitch patterns shown in FIG. 12 act in these experiments as a corollary to the more advanced knitted patterns discussed above and serve to illustrate the underlying inventive concept behind the invention.

The CFRP coupons used in the experiments consisted of the following materials. The materials used were supplied by the Advanced Manufacturing Research Centre (AMRC) at the University of Sheffield. The base fabric was a 3K weave of carbon fibre combined with an orthogonal weave of 2.3 mm. These combined to total fabric thickness of 2.8 mm. The coupons were formed into two 50×30 cm² rectangles.

The stitch patterns were then incorporated using Madeira™ conductive thread. The thread is 100% polyamide which is coated with silver (Ag). It has an electrical resistance <300 ohms m⁻¹. The thread was either sewn or fibre placed into the coupon as discussed above, following the stitch patterns of FIG. 12. The “tails” of each sensor structure thread were tagged and marked to allow for correct electrical connection during experimentation.

The two sensor rectangles with integrated sensor patterns were then sent to Codern Composites Limited, Unit E, Harrier Park, Southgate Way, Orton Southgate, Peterborough, PE2 6YQ for resin infusion and final milling into uniform coupons. Each coupon measured 325 mm×25 mm×3 mm. There were ten coupons in total, two for each sensor design.

In the nomenclature used when discussing the experiments, “I” and “O” refer to input and output tails respectively for attaching electronics to read the data output from the conductive yarn, “S” and “Z” refer to whether the input/output is measured from a straight or a zigzag stitch and the integer 1-5 refers to the stitch pattern being tested. For example, S2I_S2O refers to the input and output tails both being on the straight stitch of stitch pattern 2. It should be noted that, for stitch patterns comprising more than one type of a straight or zigzag stitch, each of these straight or zigzag stitches are considered identical. Therefore Z4I would refer to an input tail being on one of the zigzag stitches of stitch pattern 4. Where the input and output tails are from the same type of stitch from the same stitch pattern, it should be assumed that they come from the same individual stitch unless otherwise stated.

### Experiment A

### Method and Materials

In Experiment A the materials were sent to the National Physical Laboratory (NPL), Hampton Road, Teddington, Middlesex, TW11 0LW. The coupons were tested in a tensile testing machine. The coupons were tested with a cyclic load ranging from 0 to 25 KN in the first test protocol. The second test protocol used a range from 0 to 15 kN. It was noted that in the first testing protocol cracking sounds were witnessed when the coupon samples were tested in the range 0 to 25 kN and the protocol was altered to take the maximum load to 15 kN rather than 25 kN.

### Results

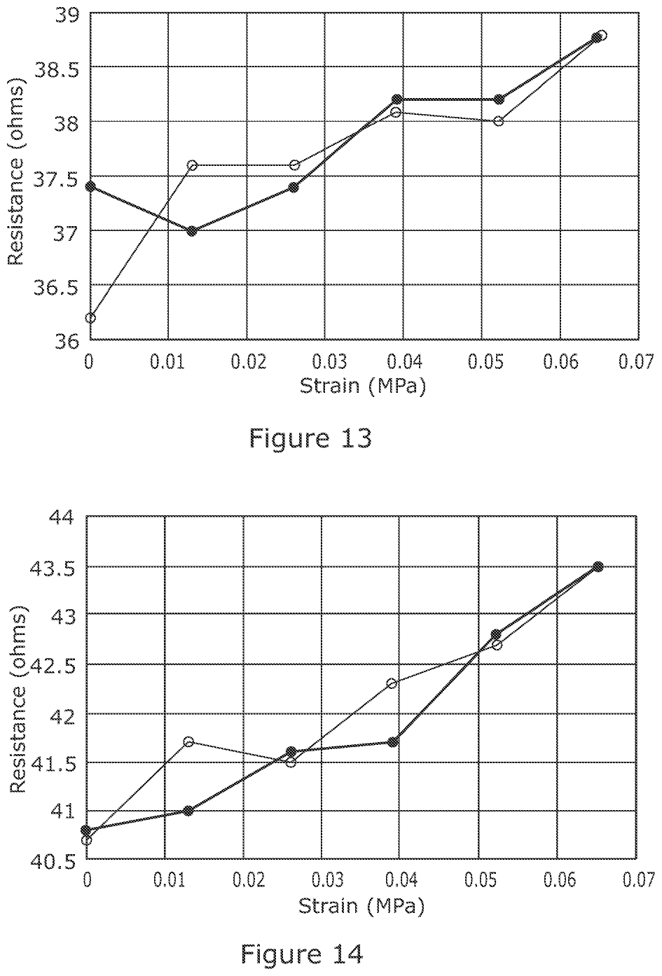

It is noted that in a couple of sensor coupons tested at NPL showed a response to the application of load. FIG. 13 shows a quasi-linear relationship between load and resistance change within an “S” sensor using the second test protocol. In FIG. 14 there is also a quasi-linear relationship seen between load and resistance change within a “Z” sensor, again using the second test protocol. In both FIG. 13 and FIG. 14, the loading line in shown in darker shading than the unloading line.

### DISCUSSION

The results show a quasi-linear relationship between load applied, or removed, and change in resistance. The lack of an exact linear relationship may be due to several material differences. These differences when removed from the coupon structure may enhance the sensitivity and repeatability of the textile strain sensor. The differences are noted below:
A requirement to keep the sensor “tails” outside the resin infusion and therefore providing an environment where the resin does not infuse evenly within the structure.
Both “S” and “Z” sensors are either sewn or fibre-placed and as such the contact points, contact areas and also fixed lengths of the sensor structure cannot be as accurately determined as when knitted int the structure.
The shape of the “S” and “Z” sensors are only an approximation of the structures that will be used in the final sensor configuration.

The output of the sensors provides a direct correlation between deformation of the structure and a measurable change in the electrical resistance. The coupon structure itself is conductive and therefore it is noted that any change in the sensor needs to be in a range that is not compromised by the overall electrical conductivity of the coupon.

### Experiment B

### Method and Materials

In Experiment B the CFRP sensor coupons were tested in house. The following was the total testing setup used in this experiment:

### Hardware

1×Fluke RMS 289 multimeter with two crocodile connectors integrated
1×laptop.

### Software

FlukeView forms software

### Results

The coupons used in Experiment B were tested using the application of a mechanical load or pressure to ascertain the output of the sensor structure. The protocols used were robust and involved the application of load using either human-based pressure or a mechanical weight applied directly to the coupon on a rigid surface.

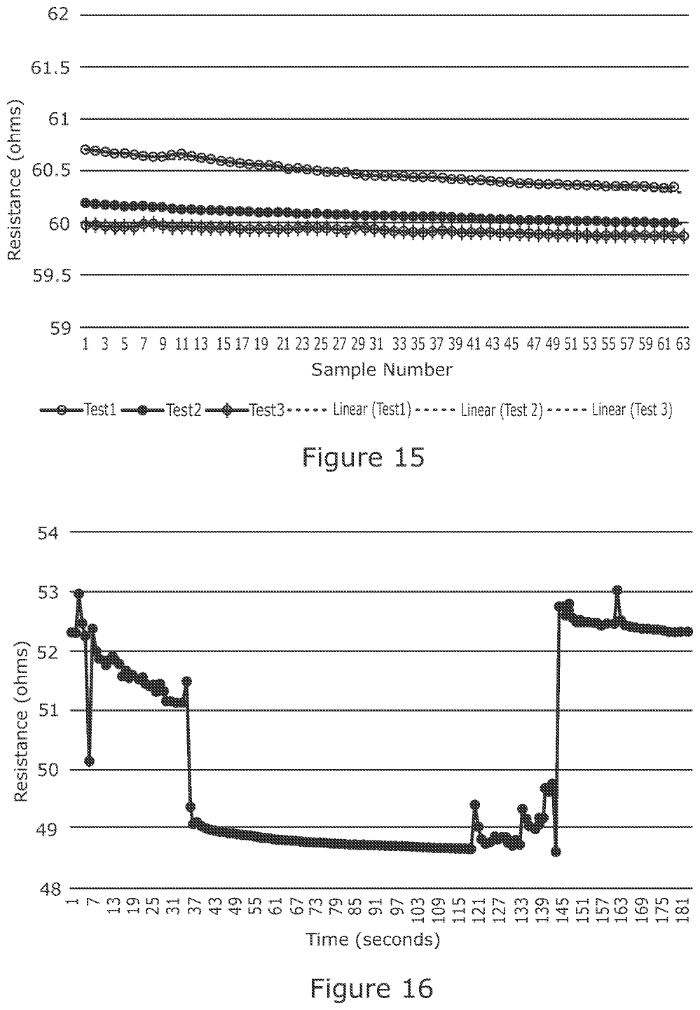

FIG. 15 shows the output of an S2I_S2O sensor when placed on an engineers' bench, connected to the hardware and software mentioned above. It is noted that there is a small downward drift in the electrical resistance when the sample is at rest and unloaded.

FIG. 16 below show the output of an S5I_S5O sensor when placed on an engineers' bench, connected to the hardware and software mentioned above. In these tests a constant load was applied to the coupon using a simple test rig. In the test results shown below a 13 kg weight was applied to the test rig to produce a pressure of 125 kPa. As stated above these test rigs are not as accurate as a scientific tensile tester, however they show the output of a textile sensor, encapsulated in a resin/carbon fibre matrix will register the pressure applied in a simple static test.

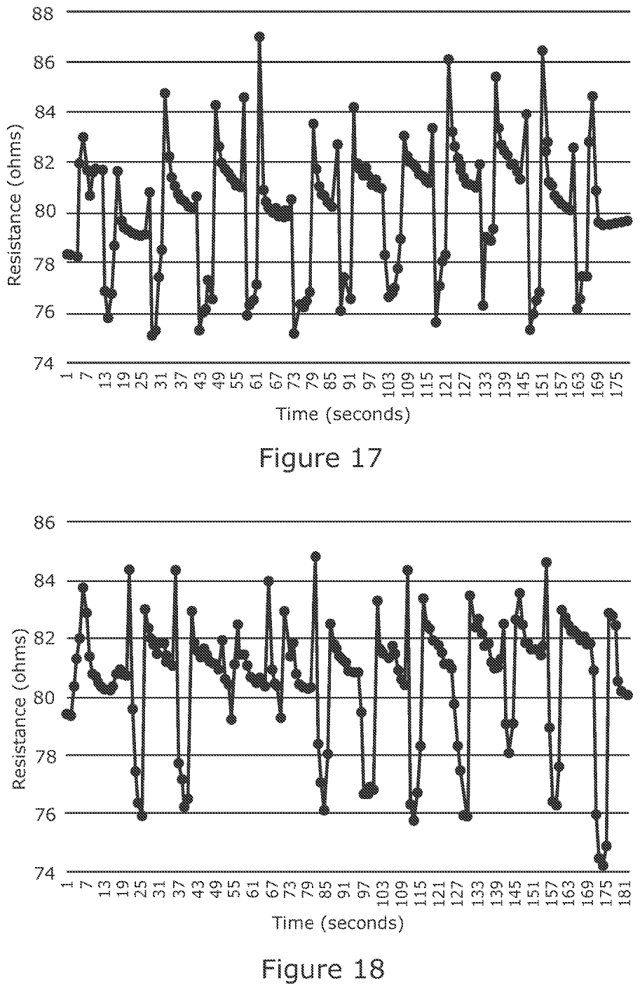

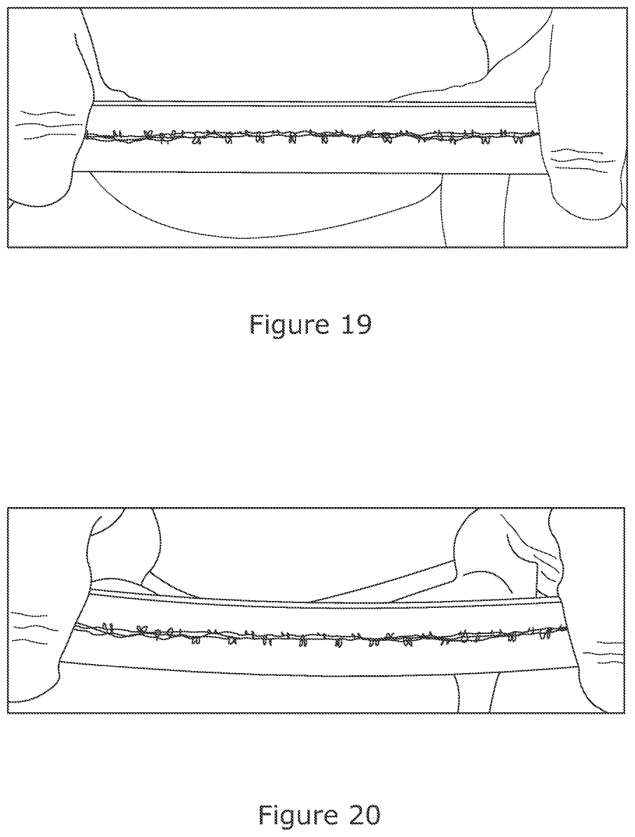

FIGS. 17 and 18 show the output of an S4I_Z4O and S5I_Z5O sensor, respectively when placed on an engineers' bench, connected to the hardware and software mentioned above. In this series of tests, an alternating load was applied to the coupon. The alternating load was by supplied by manually deforming the coupon as shown in FIGS. 19 and 20. The load was held for five seconds. It is noted that due to the manner in which the load was applied, the length of time was not standardised and nor was the load. It is also noted that the sensor signal is different for each sensor.

### DISCUSSION

It is noted that tests were performed on S2, S4, S5, Z4 and Z5 stitches. The tests reveal that a sensor at rest has a stable output with a slow drift downward of the signal. As stated above the coupons require a change in the normal manufacturing process and this may account for the drift, as might the resin infusion which will cause resin to set between sensor yarn filaments in the coupon.

When alternating pressure is applied to a CFRP coupon the pathway that the sensor signal takes would seem to influence the sensor output. The sensor outputs shown in FIGS. 17 and 18 differ slightly in signal shape and this may be due to the difference in contact points and also the length over which the signal is transmitted, as two different stitch patterns (stitch patterns 4 and 5) were used. The application of a constant pressure is noted in FIG. 16. This output is characterised by a significant resistance drop on application of the load and a consequent resistance rise on removal of the load. It is noted that this pressure was measured using a straight stitch as denoted by the “S”.

### Experiment C

### Method and Materials

In Experiment C the coupons were tested at the University of Nottingham on a BOSE Electroforce 3330. The following was the total testing setup used in this experiment:

### Mechanical

Bose 3330 Series II

### Hardware

1×Arduino, Arduino resistor shield (V3[2]) electronic unit with two crocodile connectors integrated.
1×laptop.

### Software

Putty Terminal for Arduino resistor shield (V3[2]).
Arduino IDE and the required libraries

WinTest 7 for the Bose machine.

### Results

It is noted that nine tests were performed on the stitches S2, S3,S4, Z4, Z3 and Z4. The results can be categorised into three similar sensor outputs:
Data where a coupon is deformed and the data is only captured on the “S” input and output tails.
Data where a coupon is deformed and the data is only captured on the “Z” input and output tails.
Data where a coupon is deformed and the data is captured on the “S” input and “Z” output tails.

### Sensor Output 1

The first set of results is from a coupon with stitch pattern 4, consisting of two straight and two zigzag stitches overlapping on the coupon. It is noted that these results are for an S4I_S4O sensor and so are gathered from the straight stitch sensor input and output alone whilst the coupon is placed under cyclic load in the test machine described above. The electrical resistance output was calculated using an Arduino™ Arduino resistor shield (V3[2]) electronic unit with two crocodile connectors integrated.

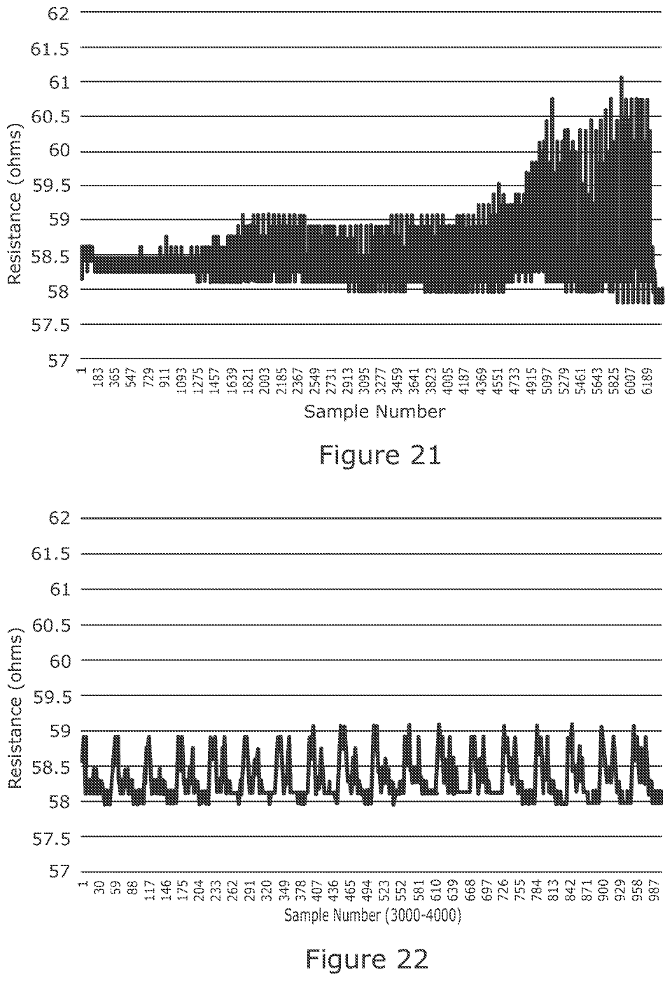

It is noted that the results are shown in two forms. The first is the total output of the test (FIG. 21) which consists of approximately 6000 samples. The second is a sample output of the test, in this case 1000 samples (FIG. 22). It is noted that, during the total test, the electrical resistance exhibits drift but that during the sample output, very little drift is noted.

### DISCUSSION

It is noted in this sensor output that there are a number of characteristics of interest. In FIG. 21 a significant drift upwards of the upper limit of the resistance over time is seen. This drift is not mirrored in the lower limit of resistance over the same time period. The drift of the sensor output is similar to that seen in some strain sensors over time due to an elongation of the sensor length and an inability to recover due to the structural nature of the composite matrix. The baseline resistance is low for the straight stitch. This is to be expected as the stitch acts as a single wire resistor with few contact points.

In FIG. 22 it is noted there is very little drift of the electrical resistance as sensor stretch may not have yet occurred. The output signal is noisy due to the sensitivity of the electronics used. That is, the electronics are set at a fixed resistance range and therefore the output is unable to distinguish between movement (pressure applied) and the fixed electronic parameters. A more robust and sensitive electronic hardware system may remove this issue. It is noted that the single straight stitch in this sensor will have very few, if any contact points with other conductive yarn sensors and as such will not note the structural movement as readily as those sensors with greater contact points.

### Sensor Output 2

The second set of results is from a coupon with stitch pattern 3, consisting of one straight and two zigzag stitches overlapping on the coupon. It is noted that these results are for a Z3I_Z3O sensor and so are gathered from the zigzag stitch sensor input and output alone whilst the coupon is placed under cyclic load in the test machine described above. The electrical resistance output was calculated using an Arduino™, Arduino resistor shield (V3[2]) electronic unit with two crocodile connectors integrated.

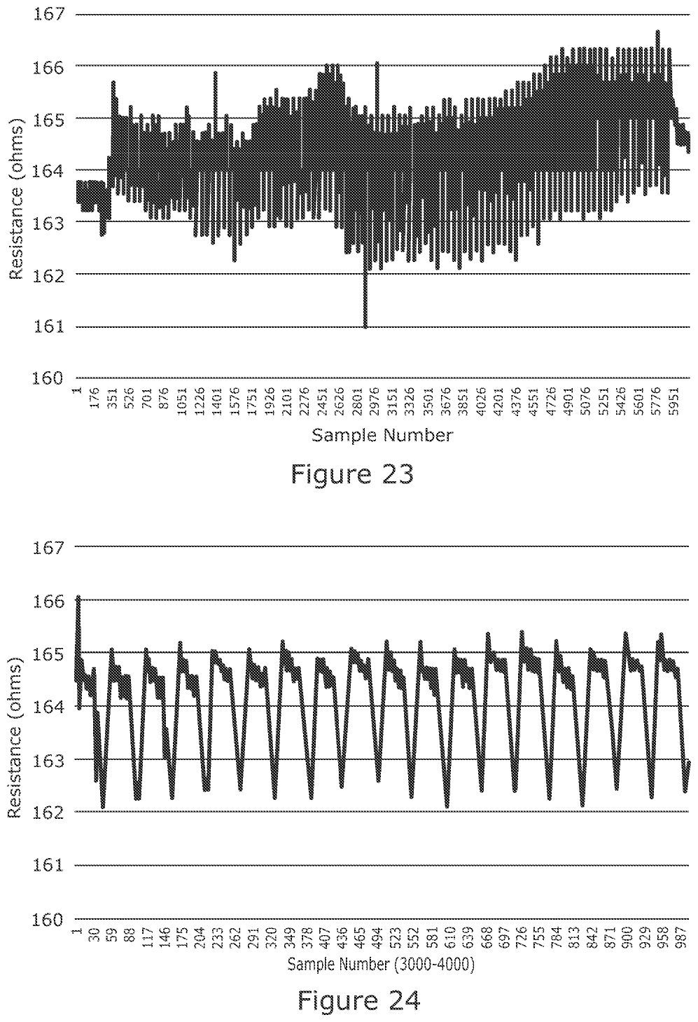

As with the test described above, the results are shown in two forms. The first is the total output of the test (FIG. 23) which consists of approximately 7000 samples. The second is a sample output of the test, in this case 1000 samples (FIG. 24). As with the straight stitch sensor output, during the total test the electrical resistance exhibits drift, although a smaller amount of drift is seen compared to the straight stitch and during the sample output, very little drift is noted.

### DISCUSSION

The baseline resistance range for the sensor in FIG. 23 is higher than that of the S4I_S4O sensor discussed above. This is expected as the measurement is taken from the zigzag stitches which mean a longer sensor length and also more contact points. A greater number of contact points is due to their path through the fabric of the coupon and hence interaction with other electrically conductive yarn. In FIG. 14 it can be seen that the sensor output is relatively stable, although there is some movement in upper and lower thresholds of resistance.

The output seen in FIG. 24 is much smoother and has a greater drop than that in FIG. 22 discussed above. As stated above there are more contact points at which to increase the contact area as well as the increased sensor length. Therefore a greater strain will mean greater drop in electrical resistance. A stitch with a greater number of contact points in one or many places will provide a greater sensitivity to measure pressure/force applied. This will change the interaction of the contact points between sensor nodes.

### Sensor Output 3

The third set of results is from a coupon with stitch pattern 2, consisting of one straight and one zigzag stitch overlapping on the coupon. It is noted that these results are for an S2I_Z2O sensor and so are gathered from straight and zigzag stitches for the sensor input and output respectively whilst the coupon is placed under cyclic load in the test machine described above. The electrical resistance output was calculated using an Arduino™, Arduino resistor shield (V3[2]) electronic unit with two crocodile connectors integrated.

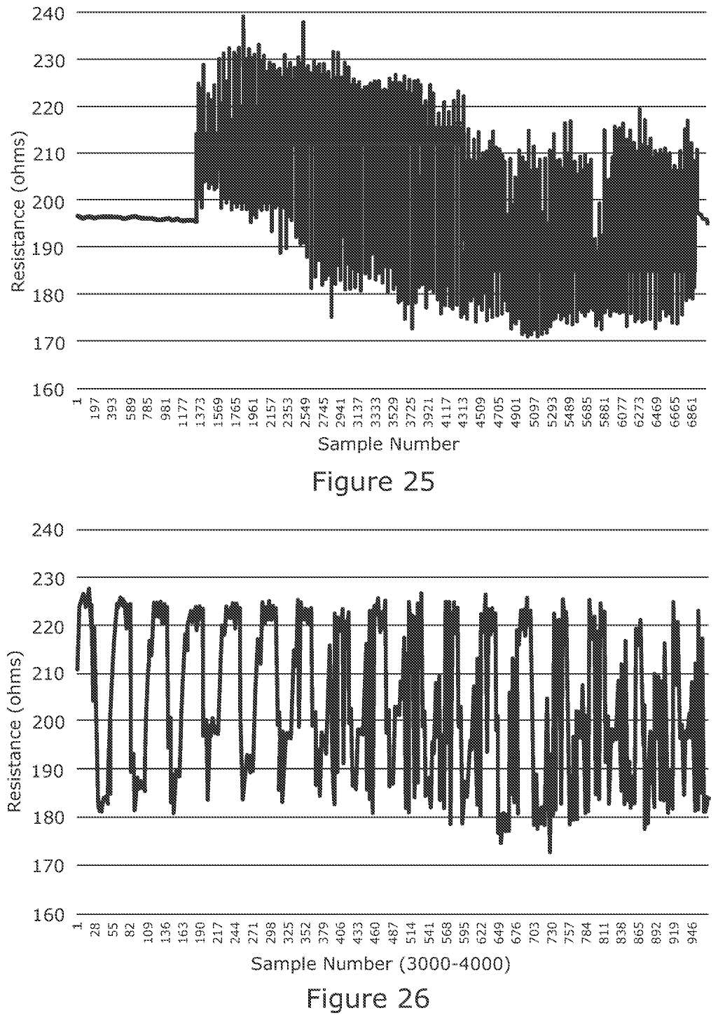

Once again, the results are shown in two forms: the total output of the test is shown in FIG. 25 which consists of approximately 7000 samples, while a sample output of the test of 1000 samples is shown in FIG. 26. It is noted that during the complete test the electrical resistance exhibits a small amount of downward drift and the electrical resistance of the total system is higher than in the previous two samples. In the test sample it is noted that once again a small downward drift is noted as well as a degradation in the signal over time from a simple wave form to a more complex waveform.

### DISCUSSION

The baseline electrical resistance for this sensor is higher than the previous two examples. This is due to an increase in the length of the sensor. The length is increased because the input is attached to the straight stitch and the output to the zigzag stitch. This significant increase in length offsets the fact that there are fewer contact points than in the Z3I_Z3O sensor discussed above.

As mentioned, a small downward drift is seen in the upper and lower boundaries of the electrical signal in FIG. 25. In FIG. 26 it can be seen that the signal output changes in shape over the duration of the sample period. The lack of a coherent pathway within the sensor structure may be a reason for this. The sensor may use different pathways when different pressures/loads are applied.

The signal drift displayed across the wider samples of Experiment C (and shown in FIGS. 21, 23 and 25) may be easily accounted for or corrected in a practical set up when in use. Appropriate signal processing techniques will be well known to those skilled in the art and can be applied to the signal to ensure accurate measurements are made over time.

Although particular embodiments of the invention have been disclosed herein in detail, this has been done by way of example and for the purposes of illustration only. The aforementioned embodiments are not intended to be limiting with respect to the scope of the appended claims, which follow. It is contemplated by the inventors that various substitutions, alterations, and modifications may be made to the invention without departing from the spirit and scope of the invention as defined by the claims.

1. A composite material comprising:
a fibre material;
a resin; and
an array comprising a conductive yarn, the array having a spatial configuration that is configured to change in response to a load applied to the composite material such that an electrical resistance of the conductive yarn changes.

2. The composite material of claim 1, wherein the array further comprises a non-conductive yarn.

3. The composite material of claim 1, wherein a density of the conductive yarn varies across the array.

4. The composite material of claim 1, wherein the array is applied to the fibre material.

5. The composite material of claim 4, wherein the array is laid into the fibre material.

6. The composite material of claim 4, wherein the array is stitched to the fibre material.

7. The composite material of claim 4, wherein the array is knitted to the fibre material.

8. The composite material of claim 7, wherein the array is warp knitted to the fibre material.

9. The composite material of claim 7, wherein the array further comprises a non-conductive yarn, the conductive yarn being laid into a knitted bed of the non-conductive yarn.

10. The composite material of claim 7, wherein the array comprises jacquard displacement actions.

11. The composite material of claim 1, wherein the spatial configuration of the array varies thereacross.

12. The composite material of claim 1, wherein the conductive yarn comprises a core surrounded by a conductive coating.

13. The composite material of claim 1, wherein the spatial configuration of the array is further configured to change in response to the load applied to the composite material such that a contact resistance of the conductive yarn changes.

14. The composite material of claim 13, wherein the contact resistance changes as a result of tunnelling of conduction electrons between adjacent regions of conductive yarn.

15. The composite material of claim 1, wherein the fibre material comprises carbon fibre.

16. A wind turbine blade comprising the composite material of claim 1.

17. An aeroplane wing comprising the composite material of claim 1.

18. A method of making a composite material, the method comprising:
providing a fibre material;
arranging an array around the fibre material, the array comprising conductive yarns; and
setting the fibre material and the array in place using a polymer matrix.

19. The method of claim 18, wherein the array is arranged around the fibre material by laying the array into the fibre material.

20. The method of claim 18, wherein the array is stitched into the fibre material.

21. The method of claim 18, wherein the array is knitted to the fibre material.

22. The method of claim 21, wherein the array is warp knitted to the fibre material.

23. The method of claim 21, wherein different knitting patterns are used across the array such that a spatial configuration of the array changes thereacross.

24. A method of measuring a strain experienced by the composite material of claim 1, the method comprising:
measuring the change in electrical resistance of the conductive yarns of the array as the load is applied to the composite material; and
relating the change in electrical resistance of the conductive yarns to the strain experienced by the composite material.
